(19) United States
(12) Patent Application Publication
(10) Pub. No.: US 2009/0319830 A1
(43) Pub. Date: Dec. 24, 2009

(54) System and Method for Automatically Testing a Model

(75) Inventors: Justyna Zander-Nowicka, Berlin (DE); Ina Schieferdecker, Zepernick (DE); Abel Marrero Perez, Berlin (DE)

Correspondence Address: THE WEBB LAW FIRM, P.C., 700 KOPPERS BUILDING, 436 SEVENTH AVENUE, PITTSBURGH, PA, 15219, US

(73) Assignee: Fraunhofer-Gesellschaft zur Foerderung der gangewandten Forschung e.V., Munchen (DE)

(21) Appl. No.: 12/486,936

(22) Filed: Jun. 18, 2009

Related U.S. Application Data
(60) Provisional application No. 61/074,205, filed on Jun. 20, 2008.

(51) Int. Cl. G06F 11/263

(52) U.S. Cl. 714/32; 714/E11.177

(57) ABSTRACT

A system for automatically testing a model of system under test includes (a) means for the automatic generation of a test harness; (b) means for automatic generation of test specifications based on the analysis of the results obtained from the simulation of the test harness; (c) means for the automatic generation of test data and test controls; (d) means for automatic evaluation of the test quality and the automatic generation of a verdict. A method for automatically testing a model system includes (a) detecting at least one feature of an input signal to the model system and (b) detecting at least one feature of an output signal of the model system, wherein the at least one feature of the input signal or the input signal is generated automatically depending on at least one feature of the at least one output signal.

### CROSS REFERENCE TO RELATED APPLICATIONS

This application claims the benefit of U.S. Provisional Patent Application No. 61/074,205 filed Jun. 20, 2008, and entitled “System and Methods for Model-Based Testing of Real-Time Embedded Systems,” the contents of which are incorporated herein by reference.

### BACKGROUND OF THE INVENTION

1. Field of the Invention

The present invention relates to automatic testing of systems and, more particularly, to automatically testing a model.

2. Description of Related Art

Functional testing is an analytic means for assessing the functional quality of system. It demands (1) the systematically selected, concrete stimulation data to trigger the behavior of the system under test and (2) a set of evaluation algorithms to assess the quality of this behavior.

### SUMMARY OF THE INVENTION

Based on the foregoing aspects of functional testing, the present invention relates to test cases that comprise the concrete test data and the corresponding evaluation mechanisms to assess whether the system reacts properly being stimulated with those data. Then, these test cases are executed together with the system under test (SUT) and the verdicts indicate how good the behavior of this SUT is.

In the presented approach we make use of the automation potential for the proposed test methods. Also, a systematic, appropriately structured, repeatable, and consistent test specification is reached. Furthermore, both abstract and concrete views are supported so as to improve the readability, on the one hand, and assure the excitability of the resulting test, on the other. The presented test method addresses all aspects of a system under test, which is a hybrid time-constrained embedded system. Here, a mix of discrete and continuous signals, time-constrained functionality, or a complex configuration is considered.

In this work, additionally, requirements-based testing is handled. That enables to find an automatic link between the requirements and created test cases. Furthermore, a graphical form of a test design increases the readability of the generated test system. The provided ready-to-use test patterns considerably reduce the test specifications effort and support their reusability. Then, an abstract and common manner of describing both discrete and continuous signals enables an automated test signals generation and their automated evaluation.

At the early stage of new (software) system functionalities development, a model of this system serves as a primary means for including the novel features. Yet there is no code, no hardware, and thus no real reference output signals for evaluation of their quality. This is the problem that has to be addressed in our solution.

Having no reference output signals does not mean that testing is impossible to achieve. We can either generate the reference signals based on the golden device concept (but they are inaccurate and cannot be used for any new version of the model we need to create a new set of the reference signals), or we can come up with another assessment mechanism that let us be independent of the reference signals. This is a first innovative procedure that we are following in our approach.

The next testing problem results from the large number of possible input scenarios (i.e., these scenarios consist of sets of input signals, in our case). The typical testing process is a human-intensive activity and as such it is usually unproductive and often inadequately done.

Therefore, the second innovation is related to test data (i.e., input signals) creation. Namely, based on the evaluation mechanisms that, by the way, serve as a test specification we are able to automatically generate the test signals to stimulate the SUT.

In the following, the combined concept is called “MiLEST”. Hence, in MiLEST a new method for both the stimulation and evaluation of embedded hybrid systems behavior is proposed. It breaks down requirements into characteristics of specific signal features. To extract the signal features a novel understanding of a signal is defined. It enables us to describe a signal in an abstract way based on its properties, such as for example, decrease, constant, maximum.

The definition of the signal feature in this particular context is the following: a signal feature (SigF), also called signal property, is a formal description of certain predefined attributes of a signal. In other words, it is an identifiable, descriptive property of a signal. It can be used to describe particular shapes of individual signals by providing means to address abstract characteristics of a signal. Giving some examples: step response characteristics, step, minimum etc. are considerable SigFs. Whereas the concept of SigF is known from the signal processing theory. In this work, the SigF is additionally considered as a means for test data generation and evaluation of the SUT outputs.

Graphical instances of SigFs are given as an example in FIG. 1. The signal presented in FIG. 1 is fragmented in time according to its descriptive properties resulting in: decrease constant, increase, local maximum, decrease, and step response, respectively. This forms the background of the solution presented herein.

A feature can be predicated by other features, logical connectives, or timing relations in our approach. We reuse the concept of signal feature for testing purposes.

Still other desirable features of the invention will become apparent to those of ordinary skill in the art upon reading and understanding the following detailed description, taken with the accompanying drawings, wherein like reference numerals represent like elements throughout.

### BRIEF DESCRIPTION OF THE DRAWINGS

FIG. 1 is a graph depicting a descriptive approach to signal feature;

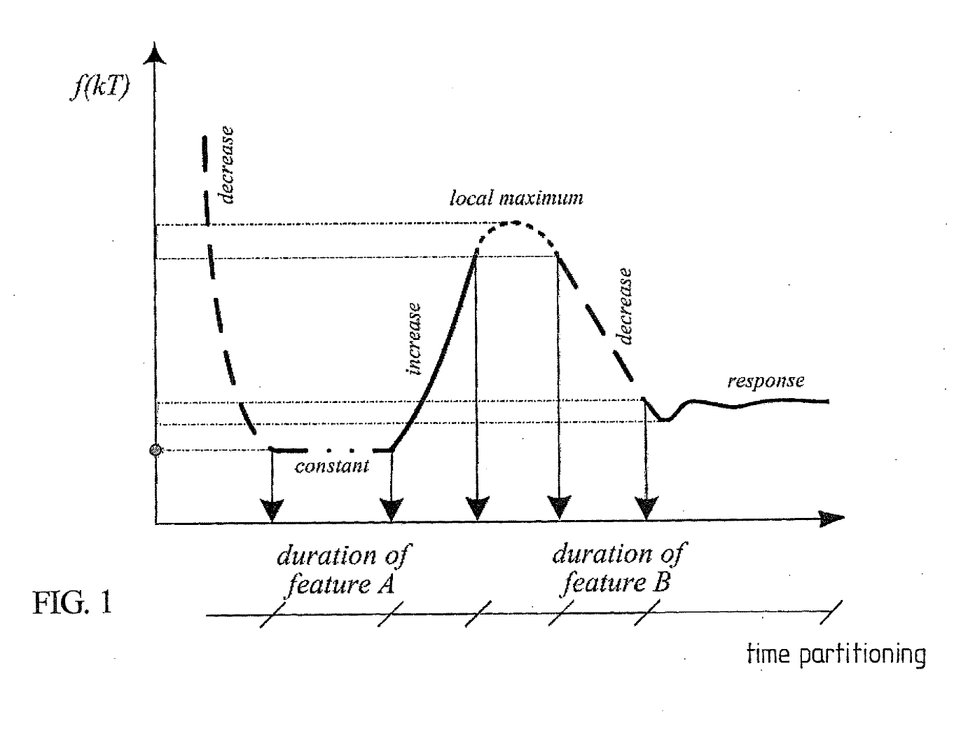

FIG. 2 is a schematic of a test harness around a pedal interpretation;

FIG. 3 is a schematic of a test specification;

FIG. 4.1 is a schematic showing a preconditions set: v const & phi_Acc increases and T_des_Drive>=0;

FIG. 4.2 is a schematic showing T_des_Drive increases;

FIG. 5 is a schematic of derived data generators;

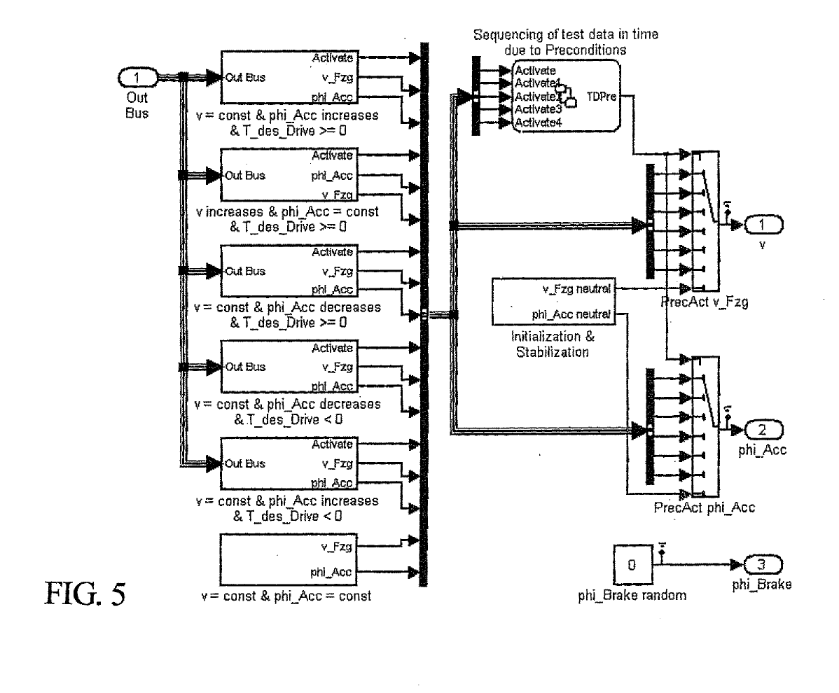

FIG. 6 is a schematic of test data for a selected preconditions set;

FIG. 7 is screen shot of parameterized GUIs of increased generation;

FIG. 8 is a flow chart depicting a test control for ordering the test cases applying minimal combination strategy;

FIG. 9 is a flow chart depicting the steps of a MiLEST Process;

FIG. 10 is a graph depicting signal-features generation; and

FIG. 11 is a schematic depicting steps for computing representatives.

### DETAILED DESCRIPTION OF THE INVENTION

The present invention will now be described with reference to the accompanying figures. It is to be understood that the specific system and method illustrated in the attached figures and described in the following specification is simply an exemplary embodiment of the present invention. Hence, specific dimensions and other physical characteristics related to the embodiments disclosed herein are not to be considered as limiting.

Based on the recognized problems and the criteria that have been proven to be advantageous in the reviewed related work, the first shape of MiLEST may be outlined. In particular, the following are in focus:

(a) Systematic and automatic test data generation process is supported. Here, not only a considerable reduction of manual efforts is advantageous, but also a systematic selection of test data for testing functional requirements including such system characteristics as hybrid, time-constrained behavior is achieved. By that, the method is cheaper and more comprehensive than the existing ones.

(b) The test evaluation is done based on the concept of signal feature, overcoming the problem of missing reference signals. These are not demanded for the test assessment any more.

(c) A catalog of classified and categorized test patterns is provided, which eases the application of the methodology and structures the knowledge on the test system being built.

(d) Some of the steps within the test development process are fully automated, which represents an improvement in the context of the efforts put on testing.

(e) A test framework enabling the specification of a hierarchical test system on different abstraction levels is provided. This gives the possibility to navigate through the test system easily and understand its contents immediately from several viewpoints.

The resulting contributions of the work proposed herewith can be divided into four main areas.

(1) Model-based test methodology for testing the functional behavior of embedded, hybrid, real-time systems based on the current software development trends from practice;

(2) In the scope of this methodology, a manner to test the behavior of hybrid systems, including the algorithms for systematic test signal generation and signal evaluation;

(3) Synthesis of a test environment so as to automate the creation of a comprehensive test system, which is achieved by means of test patterns application that are organized into a hierarchy on different abstraction levels; and

(4) Assurance of the quality of the resulting test by providing the test metrics and supporting high coverage with respect to different test aspects

The following part of this document demonstrates the application of MiLEST concepts. Even though, an application from the automotive field is chosen, the concepts are applicable in other contexts. Naturally, the approach can be used for other applications within the automotive field.

Testing, for example, the pedal interpretation component illustrates the process of test specification based on the selected system requirements. This test specification is also interpreted as specification of abstract test evaluation means in the form of validation functions (VFs). Also, test data generation patterns and their corresponding variants generation algorithms are given. Finally, the test control arranging the resulting test cases by means of the minimal combination strategy is introduced.

Here, a simplified component of the pedal interpretation of an ACC is being tested. This subsystem can be employed as pre-processing component for various vehicle control systems. It interprets the current, normalized positions of acceleration and brake pedal (phi_Acc, phi_Brake) by using the actual vehicle speed (v) as desired torques for driving and brake (T_des_Drive, T_des_Brake). Furthermore, two flags (AccPedal, BrakePedal) are calculated, which indicate whether the pedals are pressed or not. One functional requirement is given for illustration purposes, while the needed SUT interfaces are presented in the table below.

Pedal Interpretation

Interpretation of Accelerator Pedal Position:

Normalized accelerator pedal position should be interpreted as desired driving torque T_des_Drive [Nm]. The desired driving torque is scaled in the non-negative range in such a way that the higher the velocity is given, the lower driving torque is obtained.

| | | Acceleration | | Driving |
|---|---|---|---|---|
| | Velocity | pedal | | torque |
| SUT Input | (v) | (phi_Acc) | SUT Output | (T_des_Drive) |
| Value Range | <−10, 70> | <0, 100> | Value range | <−8000, 2300> |
| Unit | m/s | % | Unit | Nm |

### Table 1: Selected SUT Inputs and Outputs of Pedal Interpretation Component

Test Configuration and Test Harness:

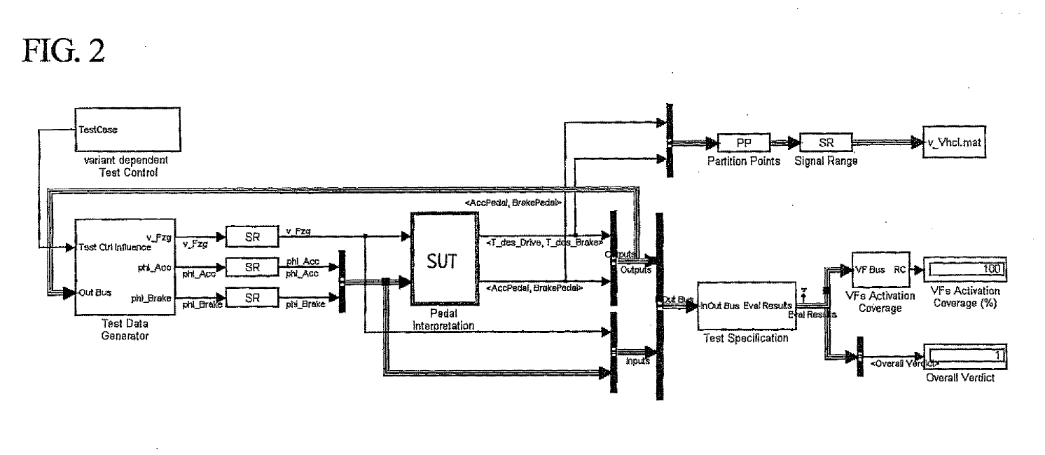

The test harness around the SUT is built automatically around it as given in FIG. 2 below. Then, further refinements of the test specification are needed.

Test Specification Design:

The design of the test specification includes all the requirements of the pedal interpretation. By that, four meaningful test sub-requirements emerge. These result in the validation functions (VFs). For the analyzed requirement, the following conditional rules are provided:
IF v is constant AND phi_Acc increases AND T_des_Drive is non-negative THEN T_des_Drive increases.
IF v increases AND phi_Acc is constant AND T_des_Drive is non-negative THEN T_des_Drive does not increase.
IF v is constant AND phi_Acc decreases AND T_des_Drive is non-negative THEN T_des_Drive decreases.

IF v is constant AND phi_Acc decreases AND T_des_Drive is negative THEN T_des_Drive increases.

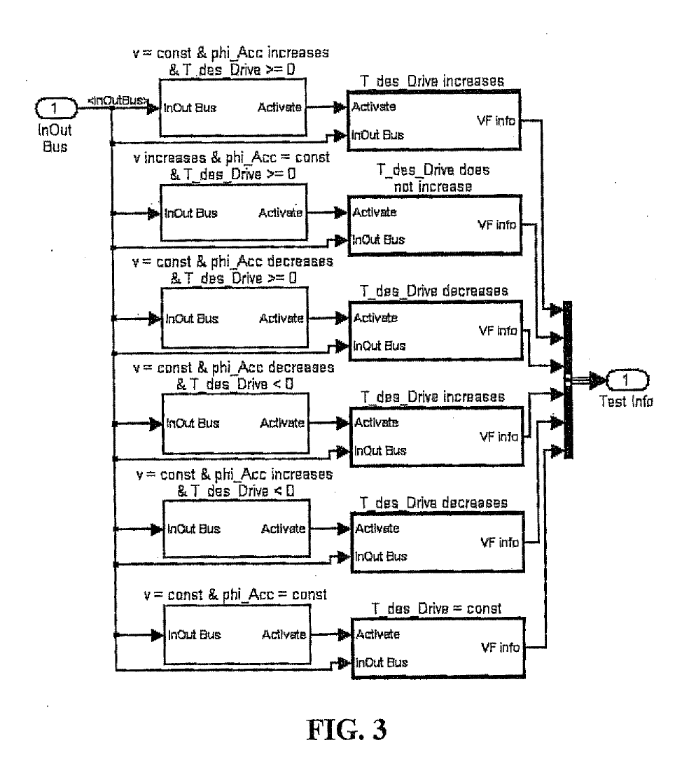

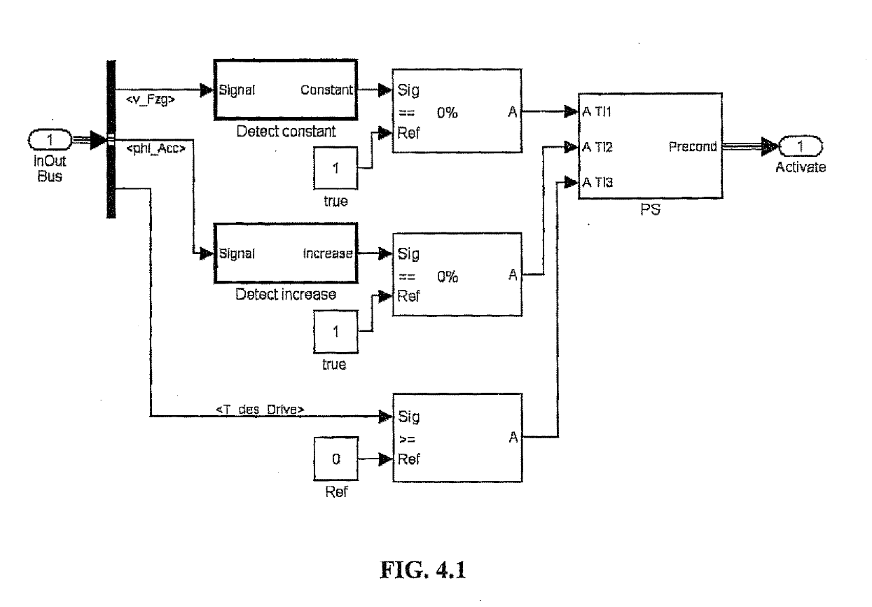

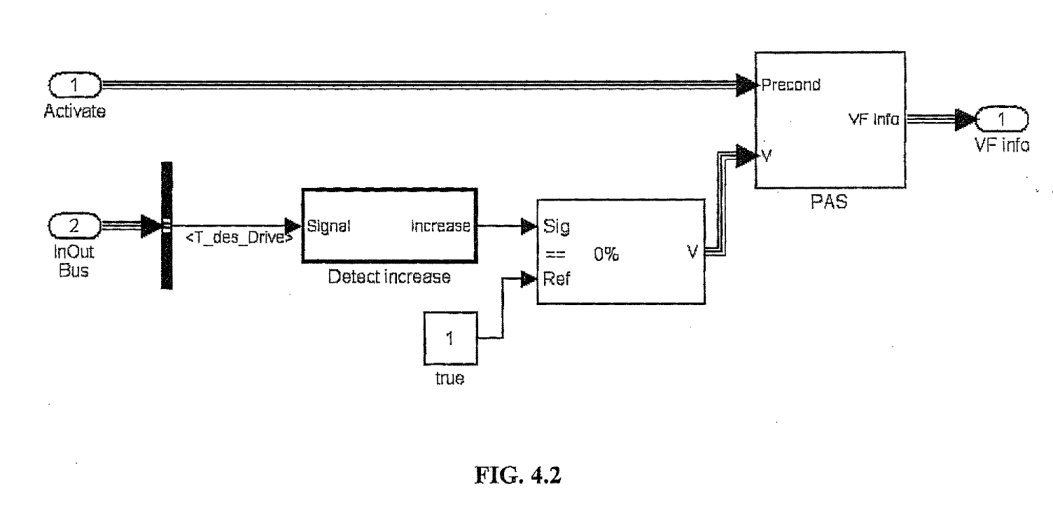

IF v is constant AND phi_Acc increases AND T_des_Drive is negative THEN T_des_Drive decreases.
IF v is constant AND phi_Acc is constant THEN T_des_Drive is constant.
   The VFs resulting from the formalized IF-THEN rules are designed as shown in FIG. 3. The actual signal-feature (SigF) checks are done in assertions when they are activated by preconditions. An insight into a VF is given in FIG. 4.1, 4.2 and is valid for the first VF from FIG. 3. If the velocity is constant and an increase in the acceleration pedal position is detected, then the driving torque should increase.

Test Data and Test Cases:

When all the VFs are ready and the corresponding parameters have been set, test data can be automatically retrieved. Using the preconditions from and the corresponding patterns for test data generation, the design given in the figure below is automatically obtained as a result of the transformations. Then, the test data generator (TDG) is applied to derive the representative variants test stimuli.

Sequencing of the SigF generation is performed in the Stateflow (SF) diagram. Signal switches are used for connecting different features with each other according to their dependencies as well as for completing the rest of the unconstrained SUT inputs with user-defined, deterministic data, when necessary (e.g., phi_Brake).

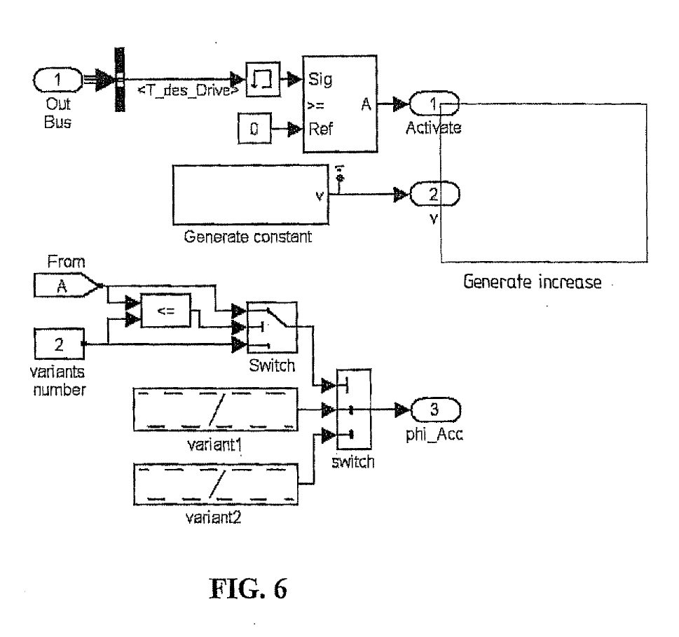

Thus, as shown in FIG. 6 (middle part) a constant signal for velocity is generated; its value is constrained by the velocity limits <−10, 70>. The partition point is 0. The TDG produces five variants from this specification. These belong to the set: {−10, 5, 0, 35, 70}.

For the acceleration pedal position limited by the range <0, 100> an increase feature is utilized. Furthermore, it is checked whether the driving torque is non-negative. This is the condition allowing the generation of the proper stimuli in the final test execution. The entire situation is depicted in the FIG. 6 (bottom part).

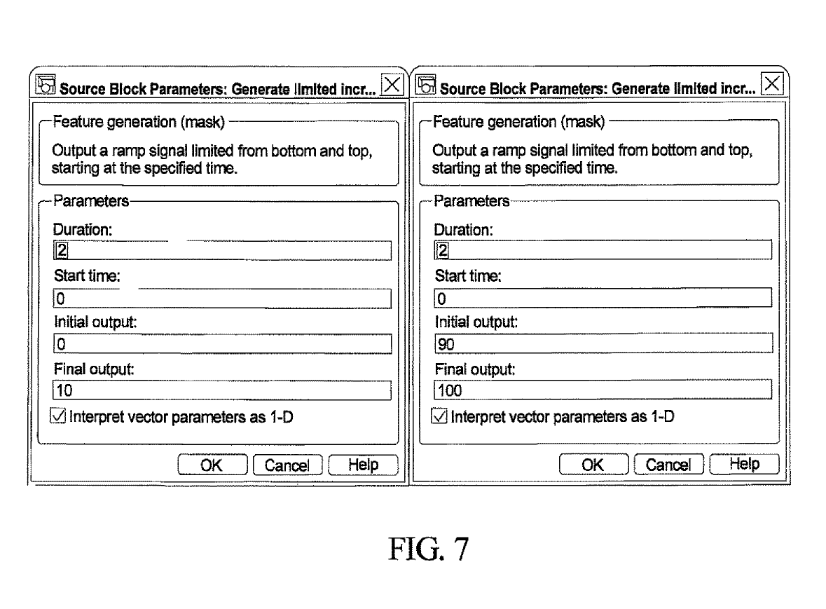

The Generate increase subsystem is shown in FIG. 7 to illustrate the variants generation. Here, two variants of the test data are produced. These are the increases in the ranges <0,10> and <90,100>. They last 2 seconds each (here, default timing is used). The brake pedal position is arbitrarily set since it is not constrained by the preconditions. Then, the combination strategy is applied according to the rule. If the current number of the variant is less than the maximal variant number, the switch block chooses the current number and lets it be the test signal variant, otherwise the variant that is last in the queue (i.e., maximum) is selected.

Test Control:

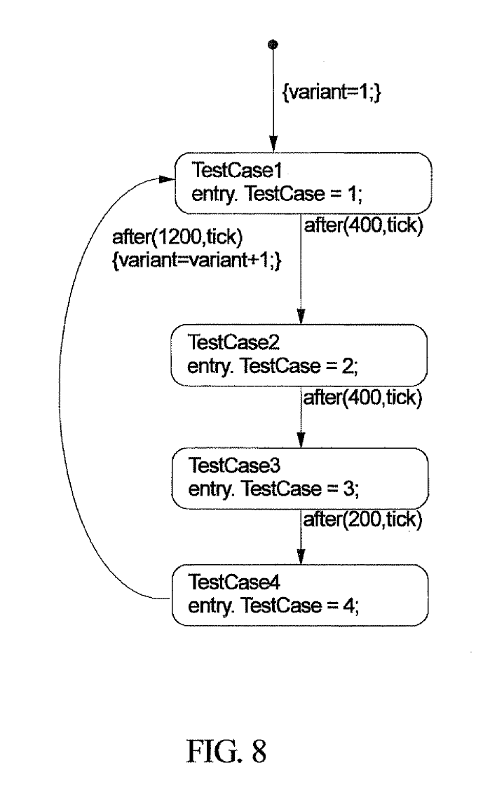

The insights into the test control are shown FIG. 8 below. Since there are no functional relations between the test cases, they are ordered one after another using the synchronous sequencing algorithm for both SigF generation and test cases. The default duration of SigF at the feature generation level is synchronized with the duration of a corresponding test case at the test control level. Technically, this is achieved by application of after(time₁, tick) expressions.

Moreover, there is a connection of variants activation on the test data level with the test control level. It happens along the application of the From block deriving the variant number from the Goto block specified on the test control level. Here, the context of minimal combination strategy of variants is applied at both test data and test control level.

Test Execution:

serving the SUT outputs after the test execution, it is difficult to assess whether the SUT behavior is correct. Firstly, every single signal would need to be evaluated separately. Then, the manual process lasts longer then a corresponding automatic one and needs more effort. Also, the human eye is evidently not able to see all the changes. This already applies to the considered example, where the increase of driving torque is not easily observed, although it exists in reality. Further on, even if using the reference data so as to compare the SUT outputs with them automatically, it still relates to only one particular scenario, where a set of concrete test signals has been used. Regarding the fact that a considerable number of test data sets need to be applied for guaranteeing the safety of an SUT, it becomes evident and how scalable the SigF-oriented evaluation process is and how many benefits it actually offers.

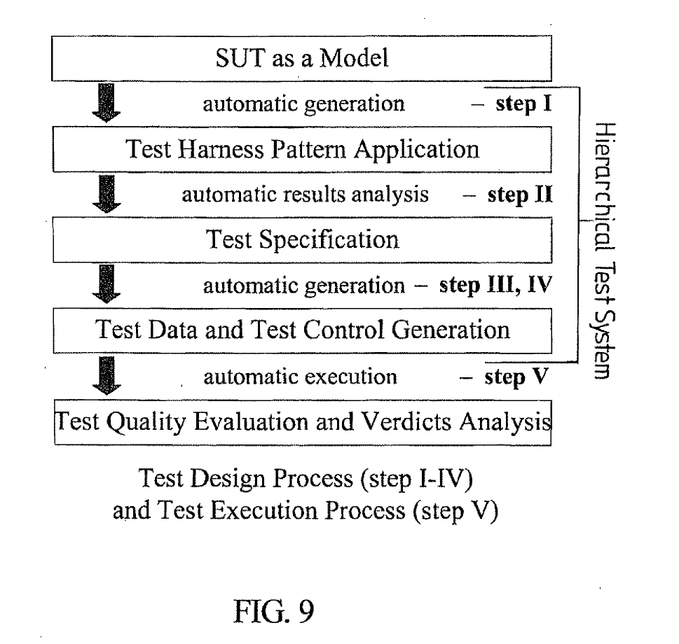

A brief description of the MiLEST method in general (FIG. 9) follows. The application of the same modeling language for both system and test design brings positive effects. It ensures that the method is relatively clear and it does not force the engineers to learn a completely new language. Thus, MiLEST is a SL add-on exploiting all the advantages of SL/SF application. It is a test specification framework, including reusable test patterns, generic graphical validation functions (VFs), test data generators, test control algorithms, and an arbitration mechanism collected in a dedicated library. Additionally, transformation functions in the form of M scripts are available so as to automate the test specification process. For running the tests, no additional tool is necessary. The test method handles continuous and discrete signals as well as timing constraints.

A starting point applying the method is to design the test specification model in MiLEST. Further on, generic test data patterns are retrieved automatically from some marked portions of the test specification. The test data generator concretizes the data. Its functionality has some similarities to the CTM method and aims at systematic signal production. The SUT input partitions and boundaries are used to find the meaningful representatives. Additionally, the SUT outputs are considered too. Hence, instead of searching for a scenario that fulfills the test objective it is assumed that this has already been achieved by defining the test specification. Further on, the method enables to deploy a searching strategy for finding different variants of such scenarios and a time point when they should start/stop.

Since at the early stage of new system functionalities development reference signals are not available, another solution has to be provided. In this work a new method for describing the SUT behavior is given. It is based on the assessment of particular signal features specified in the requirements. For that purpose a novel, abstract understanding of a signal is defined. This is the fundamental contribution of this work as both test case generation and test evaluation are based on this concept. Numerous signal features are identified; feature extractors, comparators, and feature generators are implemented. Due to their application, the test evaluation may be performed online which enables an active test control, opens some perspectives for test generation algorithms and provides extensions of reactive testing, but at the same time reduces the performance of the test system. Also, new ways for first diagnosis activities and failure management are possible.

Finally, the introduced reactive testing concept relates to the test control, but it is more powerful, especially in the context of hybrid systems. The test reactiveness is defined in some sources as a reaction of the test data generation algorithm on the SUT outputs during the test execution. In particular, the test case reacts to a defined SUT state, instead of on a defined time point. This definition is extended in this work as the test data can be additionally influenced by signals from the test evaluation. Combining this method with the traditional test control definition, the sequence of test cases execution can be organized and test data generation can be influenced depending on the verdict of the previous test case (as in TTCN-3); depending on the SUT outputs and on other test evaluation signals (e.g., reset, trigger, activation).

A series of steps of the automatized algorithms enable a construction of a hierarchical test system based on the predefined ready-to-use test data- and test analysis functions starting from an abstract test specification down to the concrete test execution. Selected examples for the specified steps follow:

Step I:

Automatic generation of test specification, test data and test control boxes that include the abstract patterns. These are meant for the concrete specification.

Step II:

Automatic analysis of the results from the execution of the test specification.

An automated dynamic analysis of the system reactions based on the system rules in the form of IF-THEN statement including logical and temporal predicates on the signal features is possible.

Here, Validation Functions (VF) constitute the implementation of a single IF-THEN rule. The VF is a group formed by preconditions-assertions block. Exactly this structure is reflected in the validation function level. Herewith, the independence of the applied test signal during the test execution is obtained on the one hand. On the other hand, the test evaluation system checks the specified test scenario constantly and simultaneously, not just at certain time steps determined by a test case. Hence, the preconditions indicate when the assertions should be assessed, not the test cases. At this point the discussion on the relation between the Test Specification (TSpec) and test evaluation from the previous subsection can be recalled. The test evaluation system represents a formal and systematic TSpec, indeed. The same applies vice versa in this case. Moreover, the verdicts set for the different assertions do not directly link to a test case. A verdict primarily belongs to its corresponding VF and therewith to a requirement as well. In this context, verdicts, here called also local verdicts, must be seen as specification-based test results in the first place, even if later related to the test cases.

The feature detection from the TSpec perspective, is the technical realization of signal evaluation. At this level more signal evaluation units appear and relate to each other by a logical AND operator. Each atomic signal evaluation unit consists of a feature extraction block in conjunction with a signal comparison block and the value of a reference SigF.

Following the IF-THEN rule that propagate the SigFs in preconditions-assertions pairs, their synchronization is required. Two cases must be distinguished since precondition blocks produce a common activation signal set for the assertions, while the assertions deliver a set of verdicts and related information.

Step III:

Automatic Generation of the Test Data.

Herewith, an automated test data generation based on the signal-feature (SigF) taxonomy and IF preconditions THEN generation sets rules is applied for getting the abstract test data. Then, an analysis of the equivalence classes and boundary values for every signal-feature type (including continuous signals) separately allows for obtaining the concrete representative test cases.

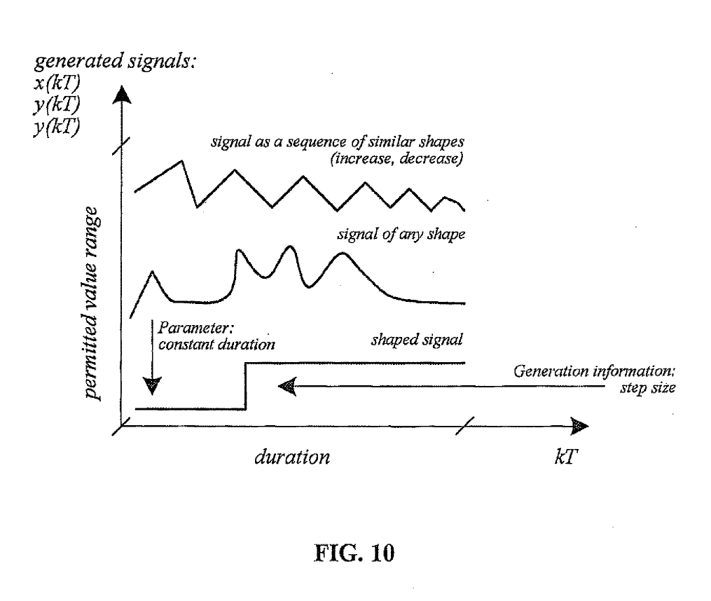

A brief overview on the scheme of feature generation is the following. Firstly, a default signal shape is defined for every SigF. Then, the range of permitted values for the signal is defined. Further on, a minimal duration time of the feature is provided, in case if needed. Otherwise, a default duration time is set. Finally, feature specifics are introduced in terms of the so-called generation information. For example, a step generation includes a size of the step, whereas an increase generation includes the shape of the increase, a slope, initial and final values. Additional parameters that need to be taken into account while feature generation relate to the evaluation mechanism for a particular feature. They must be set following the values of the same parameters that have been applied in the extraction part. A simple example is a step, for which the duration of constant signal appearing before the step, must be set. Otherwise, the feature detection mechanism could not work properly. Then, generating the step, the duration of the generated constant signal, must be set on the minimal value specified within the extraction so as to be detectable at all (FIG. 10).

In summary, a generic pattern for signal generation is always the same—a feature is generated over a selected signal and the parameters are swept according to a predefined algorithm; however some feature specifics must be included for an actual generation of every single SigF. Then, the variants of such SigF are generated automatically as well. At least three different methods can be used to choose the representatives (i.e., variants) of the equivalence class, namely random testing, mean value testing and boundary testing.

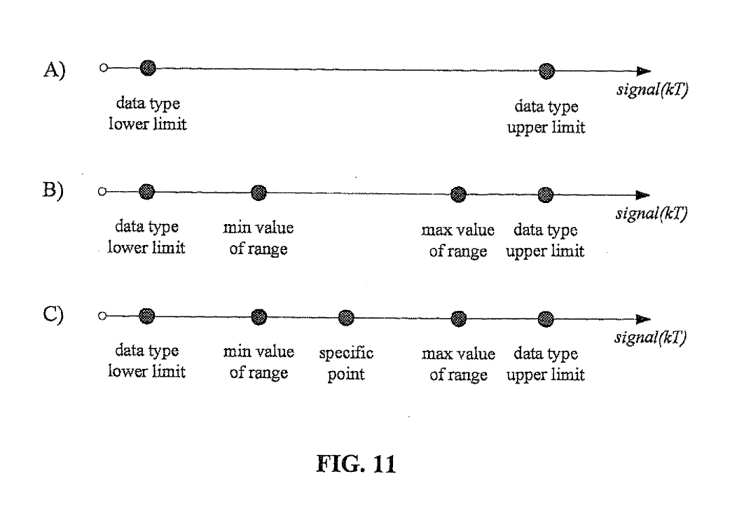

In the method proposed in this work a pattern is followed. Dedicated blocks, called signal range and partition points are provided for every SUT input and output interfaces in order to let the test engineer set the boundaries. Three types of such boundaries are distinguished. These result from the applied data type, the signal range and specific partition points. Data type boundary is determined by the lower and upper limit of the data type itself. It is limited by its physical values. For example, the lower limit of temperature is absolute zero (i.e., 0 K or −273.15° C.); an unsigned 8-bit value has the range from 0 to 255. The range of the signal belongs to the data type range and it is specific for the SUT. For example, if water is the test object, the temperature of water may be specified as the one between 0° C. and 100° C. Finally, the partition points are of concern since they constitute the specific values of critical nature belonging to the signal range (FIG. 11).

A number of algorithms are proposed for signal variants generation depending on the SigF type. The analysis of SigF types, equivalence partitioning and boundaries are used in different combinations to produce the concrete test data variants.

Then, the generated variants have to be combined with each other and sequenced in time. The algorithms for those procedures are given in Section 3.5.3 and 3.5.4 respectively.

Step IV:

Automatic Generation of the Test Control.

Step V:

Automatic Analysis of Verdicts and Quality of the Designed and Executed Test.

Based on the test assessment automatic decisions on test generation can be taken.

Test quality (TQ) is estimated applying different metrics. For the purpose of this work several metrics have been defined, mainly based on the functional relevance. In Section 3.8, they are discussed and ordered according to the test specification phases supported by MiLEST methodology. It is to be understood that the list is not comprehensive and can be extended in many directions.

The invention has been described with reference to the desirable embodiments. Modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A system for automatically testing a model of system under test comprises:
means for the automatic generation of a test harness;
means for automatic generation of test specifications based on the analysis of the results obtained from the simulation of the test harness;
means for the automatic generation of test data and test controls;
means for automatic evaluation of the test quality and the automatic generation of a verdict.

2. The system according to claim 1, further comprising:
means for the detection of at least one signal feature (SigF) in an input signal to the model system; and
means for detecting at least one signal feature in an output signal of the model system, where in the at least one signal feature in the input signal or the at least one signal feature in the output signal are automatically generated based on at least one feature of the at least one output signal.

3. The system according to claim 2, further comprising:
means for automatically generating a test data generator for generating the at least one input signal or a test evaluator for the testing of the at least one output signal.

4. The system according to claim 2, wherein the temporal sequence of the at least one input signal is controlled by features of the at least one output signal.

5. The system according to claim 2, wherein depending on features of the at least one output signal based on predetermined criteria, at least one verdict is automatically generated.

6. The system according to claim 5, wherein based on the at least one verdict, the at least one input signal is controlled.

7. The system according to claim 1, wherein the system is implemented in a hardware processor.

8. The system according to claim 1, wherein the system is implemented in software.

9. The system according to claim 8, wherein the software system comprises at least one module in the form of a toolbox.

10. The system according to claim 1, wherein the model of system under test is a representation of a mathematical model of a discrete, continuous or hybrid time constrained system.

11. The system according to claim 1, further comprising:
means for synchronizing a sequencing of test cases, and providing verdicts and evaluation features.

12. The system according to claim 3, wherein the automatically generated data generator or the test evaluator comprise hierarchical levels.

13. The system according to claim 12, wherein the hierarchical levels comprise a Feature Generation Level, a, Feature Detection Level, a Test Case Level, a Test Harness Level, a Validation Function Level, and a Test Requirement Level.

14. A method for automatically testing a model system, wherein the method comprises the steps of:
detecting at least one feature of an input signal to the model system; and
detecting at least one feature of an output signal of the model system, wherein the at least one feature of the input signal or the input signal is generated automatically depending on at least one feature of the at least one output signal.

15. A method for automatically generating a test model system, wherein the method comprises the step of automatically generating a test data generator for generating the at least one input signal or a test evaluator for the testing of the at least one output signal.

16. A simulation system comprising means for synchronizing a sequencing of test cases, and providing verdicts and evaluation features.
